(19) United States
(12) Patent Application Publication
(10) Pub. No.: US 2024/0369970 A1
(43) Pub. Date: Nov. 7, 2024

(54) METHOD FOR MANUFACTURING A TIMEPIECE ASSEMBLY, AND TIMEPIECE ASSEMBLY

(71) Applicant: ROLEX SA, Geneva (CH)

(72) Inventors: Florian Calame, Epalinges (CH); Stefano Henin, Saint-Prex (CH); Xavier Multone, Lausanne (CH); Benoît Vincent-Falquet, Annecy (FR)

(73) Assignee: ROLEX SA, Geneva (CH)

(21) Appl. No.: 18/565,400

(22) PCT Filed: Jun. 10, 2022
(86) PCT No.: PCT/EP2022/065840

§ 371 Date: Nov. 29, 2023

(30) Foreign Application Priority Data
Jun. 11, 2021 (EP) 21178990.4
Feb. 18, 2022 (CH) 000159/2022

(51) Int. Cl. G04B 13/02; G04D 3/00

(52) U.S. Cl. CPC G04B 13/02; G04D 3/0084

(57) ABSTRACT

The timepiece assembly includes a first timepiece component (10) assembled with a distinct second timepiece component (20), the first timepiece component (10) having at least one functional part and a receiving opening (11) which can constitute a connecting hole distinct from the functional part, the wall delimiting the receiving opening (11) forming a first connecting surface (12), the second timepiece component (20) having a second connecting surface (22) and being assembled securely with the first timepiece component by direct or indirect contact between the respective first and second connecting surfaces (12, 22) at a securing surface, wherein at least one of the first and second connecting surfaces (12, 22) or a third connecting surface of an optional intermediate third component (30) is made of silicon oxidized by heat treatment so that the first and second timepiece components are secured to one another by the growth of an oxidized silicon layer

The present invention relates to a timepiece assembly of at least two timepiece components. It also relates to a timepiece movement and to a timepiece comprising at least one such timepiece assembly. It also relates to a method for manufacturing such a timepiece assembly.

Ceramic is being increasingly used in horology, for example to form timepiece staffs, because its intrinsic mechanical properties, notably hardness and insensitivity to magnetic fields are highly advantageous for numerous timepiece components.

The traditional solutions used for assembling timepiece components, which solutions were designed for metallic materials, are not, however, always suitable or optimal for ceramic. In addition to this, silicon is likewise being increasingly used for the manufacture of timepiece components, and because of its fragility, the traditional solutions for assembling timepiece components are likewise not always suitable or optimal for silicon.

Thus, one object of the present invention is to improve timepiece assemblies and notably to define a timepiece assembly solution that is particularly well suited to the use of ceramics.

More specifically, one object of the invention is to define a timepiece assembly solution that is reliable, durable and easy to implement.

To that end, the invention relates to a timepiece assembly comprising a first timepiece component assembled with a distinct second timepiece component, the first timepiece component comprising a receiving opening or connecting hole, the wall delimiting said receiving opening or connecting hole forming a first connecting surface, the second timepiece component comprising a second connecting surface and being assembled securely with the first timepiece component by direct or indirect contact between the respective first and second connecting surfaces of said first and second timepiece components at a securing surface, wherein at least one of the first and second connecting surfaces or a third connecting surface of an optional intermediate third component is made of silicon oxidized by heat treatment so that the first and second timepiece components are secured to one another by the growth of a layer of oxidized silicon.

The first timepiece component may comprise at least one functional part and a receiving opening distinct from said functional part.

According to a first embodiment, the contour of the receiving opening of the first timepiece component is closed, and this receiving opening or connecting hole may have a constant cross section over the entirety of its first connecting surface.

According to a second embodiment, the contour of the receiving opening opens onto the external perimeter of the first timepiece component and the receiving opening or connecting hole may have a constant cross section over the entirety of its first connecting surface, the height of which is comprised between a portion of the total thickness and the total thickness of the first timepiece component.

Furthermore, the second timepiece component may have a portion of variable cross section, notably which increases continuously from a boundary with its second connecting surface, this portion of continuously increasing cross section being positioned outside the receiving opening, or connecting hole, in the immediate vicinity of an end of said receiving opening.

The invention also relates to a method for manufacturing a timepiece assembly comprising a first timepiece component and a distinct second timepiece component, wherein said method comprises the following steps:
assembling said two timepiece components in a minimal-clearance intermediate configuration such that the second timepiece component is positioned in a connecting hole or receiving opening of the first timepiece component, a first connecting surface of the first timepiece component being positioned facing a second connecting surface of the second timepiece component, optionally via the intermediary of an interior and exterior third connecting surface of an intermediate third component of the sleeve type, at least one of the first and second connecting surfaces or an optional interior and exterior third connecting surface being made of silicon;
heat treating the timepiece assembly in its intermediate configuration so as to obtain growth of a layer of oxidized silicon on the at least one connecting surface made of silicon until a predefined level of securing-together of the two timepiece components is obtained.

The invention is more particularly defined by the claims.

These objects, features and advantages of the present invention will be set out in detail in the following description of particular embodiments given by way of nonlimiting example in connection with the attached figures among which:

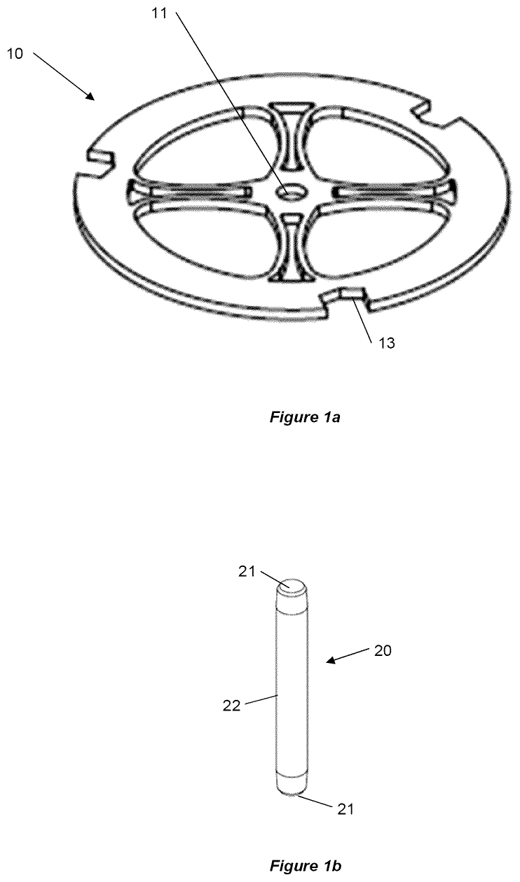

FIGS. 1a and 1b depict a first step in a timepiece assembly method according to one embodiment of the invention.

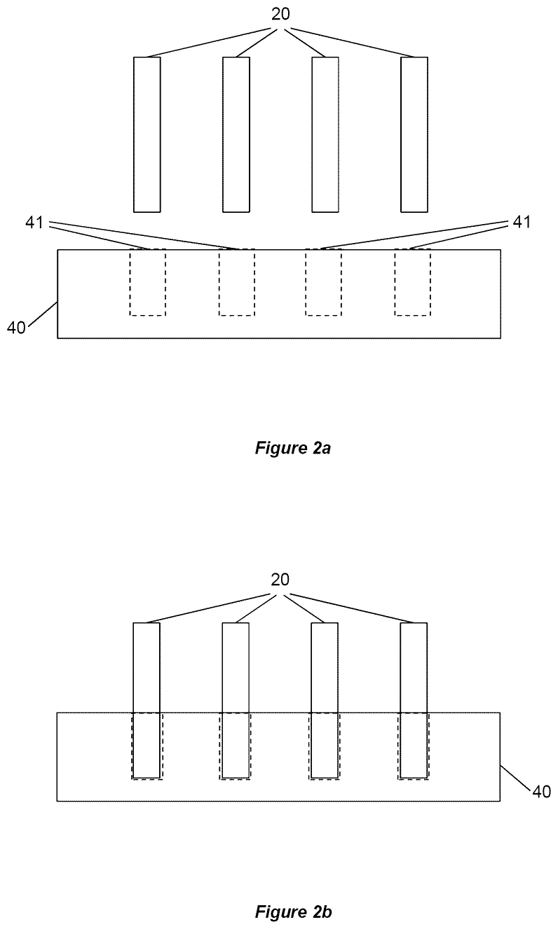

FIGS. 2a and 2b depict a second step in the timepiece assembly method according to one embodiment of the invention.

FIG. 3 depicts a third step in the timepiece assembly method according to one embodiment of the invention.

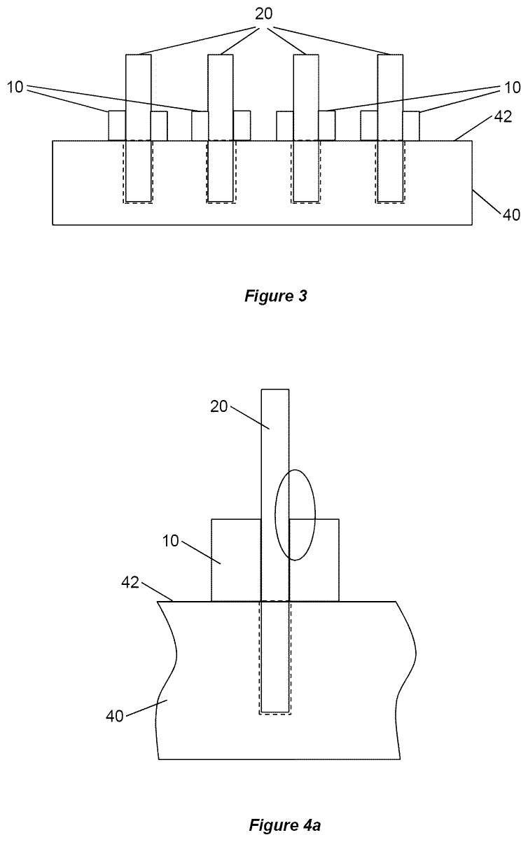

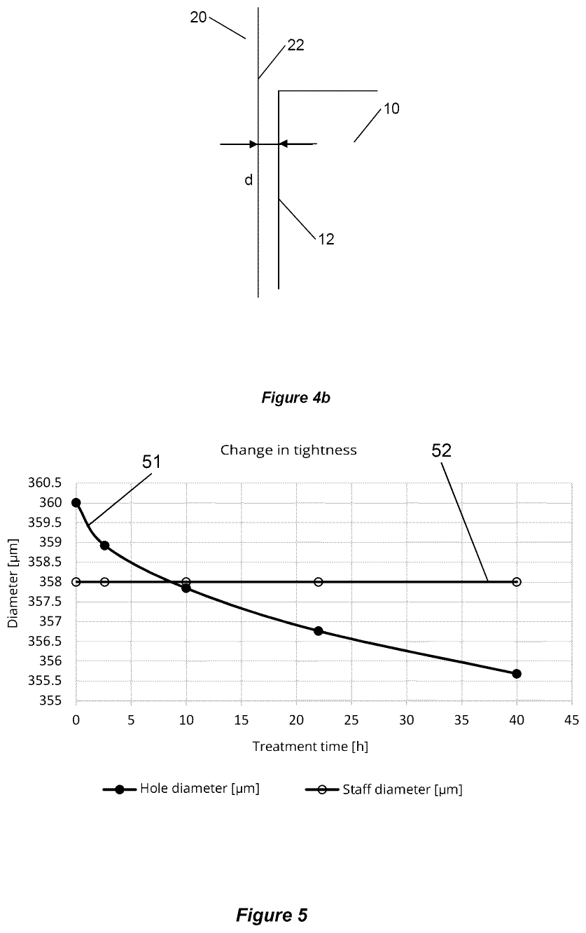

FIGS. 4a and 4b depict enlarged views of the third step of the timepiece assembly method according to one embodiment of the invention.

FIG. 5 depicts the change in tightness of the assembly in a fourth step of the timepiece assembly method according to one embodiment of the invention.

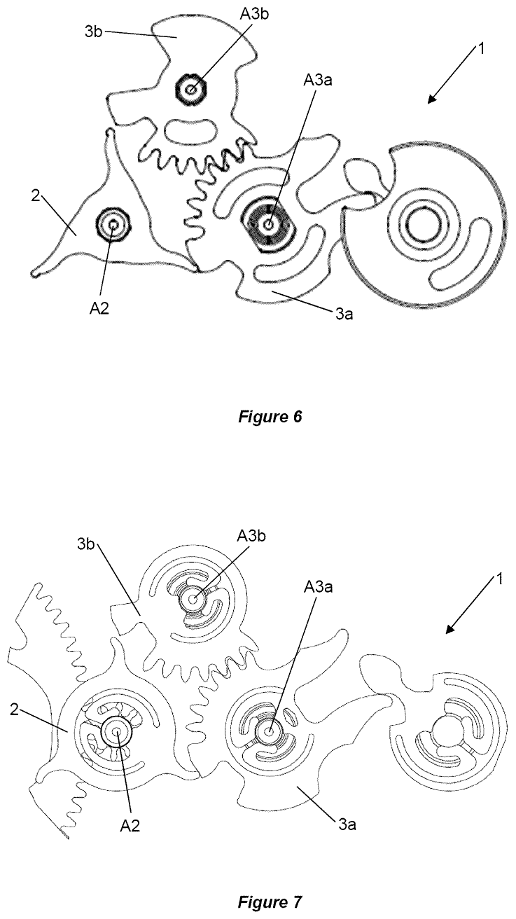

FIG. 6 depicts part of a timepiece movement comprising timepiece assemblies according to a first embodiment of the invention.

FIG. 7 depicts part of a timepiece movement comprising timepiece assemblies according to a second embodiment of the invention.

FIG. 8 depicts a first variant of the third step of the timepiece assembly method according to one embodiment of the invention.

FIG. 9 depicts a second variant of the third step of the timepiece assembly method according to one embodiment of the invention.

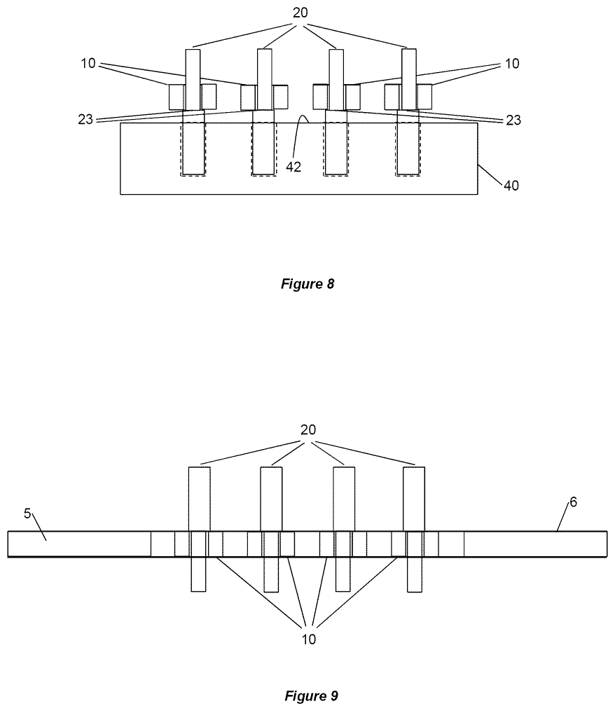

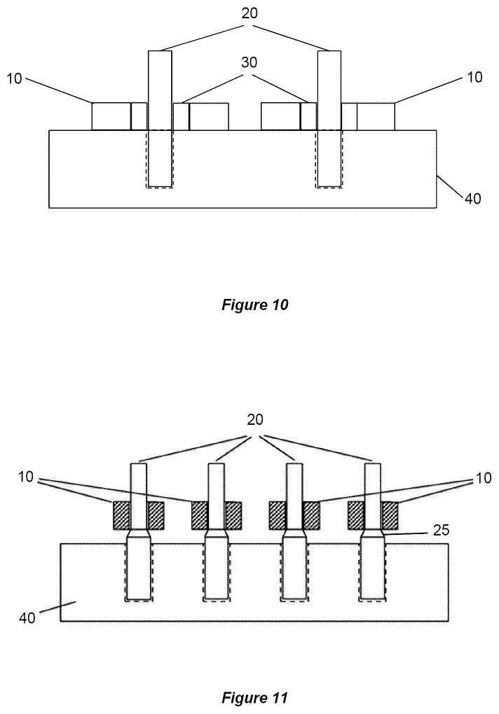

FIG. 10 depicts a third variant of the third step of the timepiece assembly method according to one embodiment of the invention.

FIG. 11 depicts a fourth variant of the third step of the timepiece assembly method according to one embodiment of the invention.

FIGS. 12 and 13 depict, in enlarged schematic views, the third step and the assembly obtained by implementing the fourth step of the timepiece assembly method according to the fourth variant of the embodiment of the invention.

FIG. 14 depicts a fifth variant of the third step of the timepiece assembly method according to one embodiment of the invention.

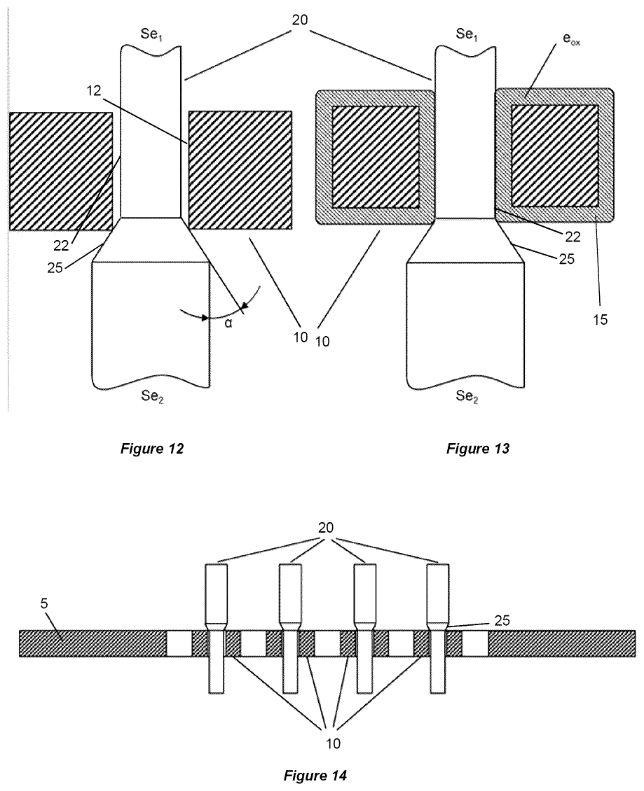

FIG. 15 depicts a balance wheel provided with a receiving opening for receiving a balance-wheel pin.

FIG. 16 depicts a balance-wheel pin assembled with a balance wheel of FIG. 15 according to one embodiment of the invention.

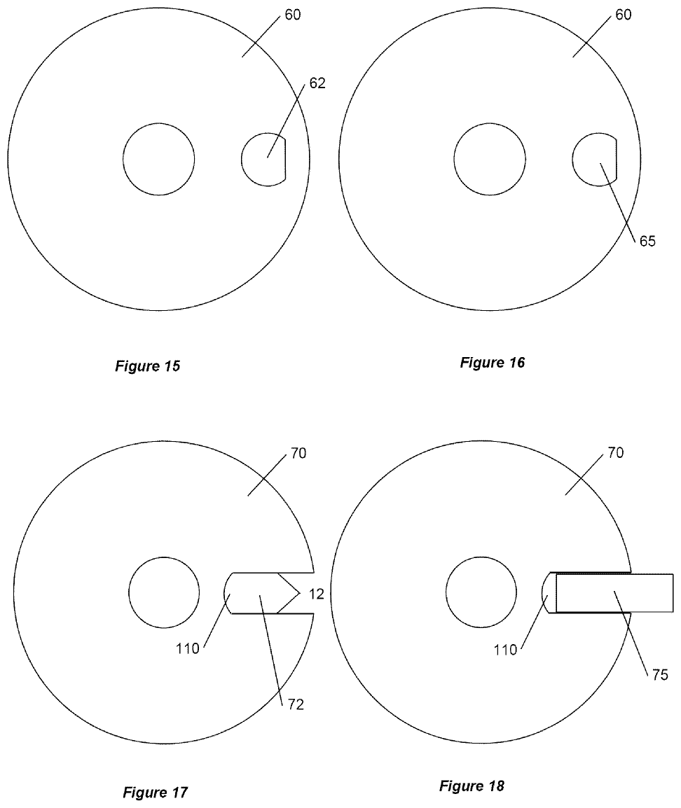

FIG. 17 depicts a balance wheel provided with a receiving opening for receiving an impulse pin.

FIG. 18 depicts an impulse pin assembled with a balance wheel of FIG. 17 according to one embodiment of the invention.

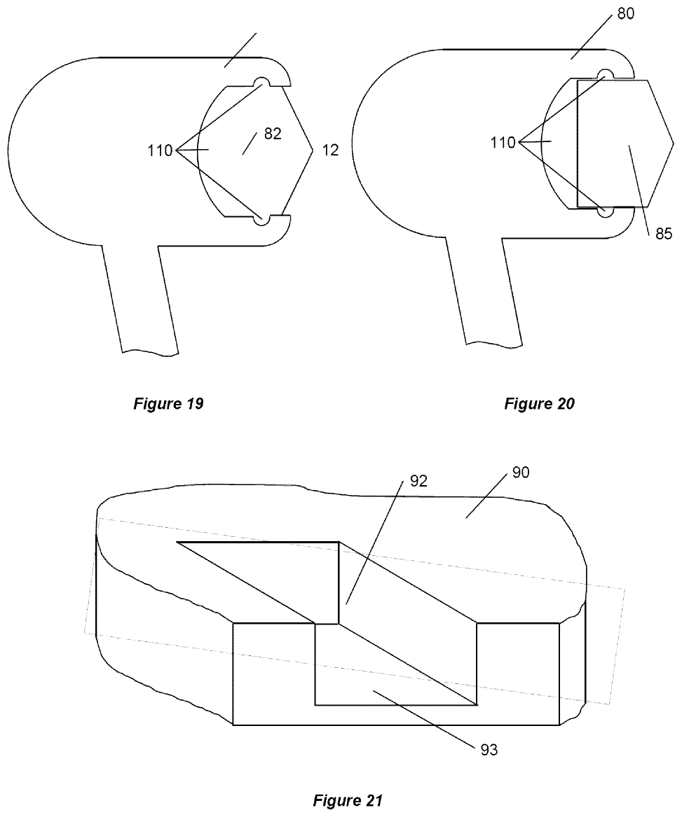

FIG. 19 depicts a jumper provided with a receiving opening for receiving a jumper spur.

FIG. 20 depicts a jumper spur assembled with a jumper of FIG. 19 according to one embodiment of the invention.

FIG. 21 depicts a first component comprising a female part forming an open receiving opening according to another embodiment of the invention.

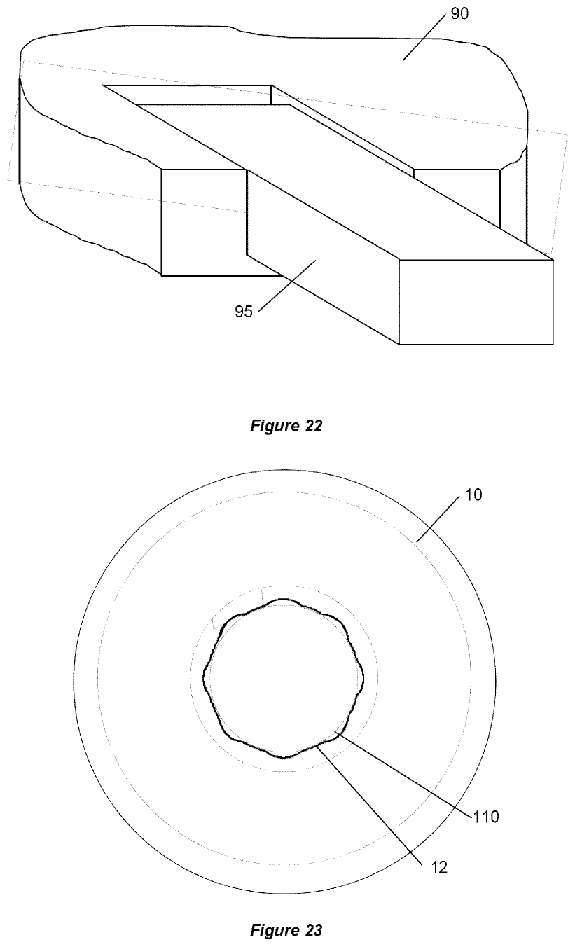

FIG. 22 depicts a second component comprising a male part assembled with the first component of FIG. 21 according to this other embodiment of the invention.

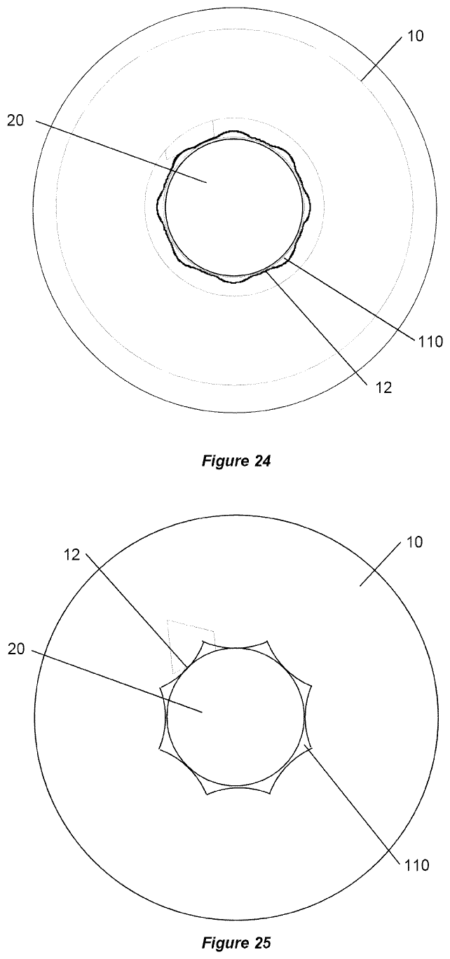

FIGS. 23 to 26 depict connecting surfaces which are fluted according to various embodiments of the invention.

The invention advantageously relates to a method for manufacturing a timepiece assembly. The objective of such a method is to assemble with one another securely at least two distinct timepiece components to form a solidly connected entity that will be referred to here as a timepiece assembly. At least one of the timepiece components of the timepiece assembly is advantageously predominantly made of ceramic, which is to say is completely or partly made of ceramic and/or advantageously contains at least 50 wt % ceramic. The ceramic is advantageously present on the connecting surface of said timepiece component predominantly made of ceramic.

The ceramic may notably be a zirconia, particularly yttria-stabilized zirconia, notably 3 mol % yttria-stabilized zirconia or 2 mol % yttria-stabilized zirconia, or a monocrystalline or polycrystalline alumina or an alumina-zirconia combination. In a variant, the ceramic may be composed of a nitride, a carbide and/or a boride of refractory metals, alone or in combination with one another, as well as in combination with oxides such as the aforementioned zirconia and alumina.

A method for manufacturing a timepiece assembly will now be described.

A first step in the method according to the embodiment is to procure two distinct timepiece components that are to be assembled to form a solidly connected entity.

FIG. 1a thus illustrates a first timepiece component 10, which according to the embodiment is a wheel made of silicon. It comprises a receiving opening 11 in its central part, also called “connecting hole”, corresponding to a hub of the wheel. According to this embodiment, the receiving opening 11 (connecting hole) has a transverse cross section, which is to say a cross section perpendicular to its central axis, that is circular in shape. As a variant, this cross section could have some other shape, for example ellipsoidal, ovoid, polygonal, etc. and/or could comprise, along its circumference, at least one fluting, the cross section of which can have any type of geometry. The at least one fluting is provided for facilitating both the growth of the silicon oxide layer and the preassembly of the two timepiece components. The wall delimiting this receiving opening forms a connecting surface 12, as will be specified hereinafter. The wheel additionally comprises a peripheral part comprising notches or teeth 13 which are intended to collaborate with another timepiece assembly within a timepiece movement. This peripheral part forms a functional part of the first timepiece component 10. Advantageously, this first timepiece component 10 can be manufactured in silicon from a standard silicon wafer, engraved using a traditional deep reactive ion etching method (known by its abbreviation DRIE). In this method, a plurality of identical wheels are formed simultaneously on the same silicon wafer.

FIG. 1b illustrates a second timepiece component 20, distinct from the first timepiece component, which is a staff made of ceramic according to the exemplary embodiment, intended for assembling in the hub of the wheel of FIG. 1a to allow the wheel to be arranged with the ability to rotate within a timepiece movement. According to this embodiment, the second timepiece component 20 is therefore intended to be mounted through the receiving opening 11 (the connecting hole) of the first timepiece component 10. To this end, in this embodiment, the second timepiece component 20 has a transverse cross section, which is to say a cross section perpendicular to its axis of rotation, which is circular. As a variant, this cross section could have some other shape, for example ellipsoidal, ovoid, polygonal, etc. The two ends 21 of the staff are intended to be mounted within a timepiece movement allowing the staff to rotate with minimal friction. The timepiece staff may be manufactured in ceramic from a bar using a laser turning method followed by tribofinishing, making it possible to obtain a precise geometry and a controlled surface finish. The peripheral surface of the second timepiece component 20 comprise a second connecting surface 22 intended for fixing to the first connecting surface 12 of the first timepiece component 10 to form the timepiece assembly of the two timepiece components, as will be detailed later. Thus, the second timepiece component 20 has a connecting surface 22 of male type, intended to collaborate with a connecting surface 22 of female type belonging to the first timepiece component 10.

FIG. 2a depicts an intermediate phase of the second step of the assembly method, in which phase a plurality of second timepiece components 20 are brought closer to a support 40 pierced with blind holes 41. This support 40 is an intermediate element, used temporarily in the manufacturing method. It does not form part of the timepiece assembly. It is made of any material resistant to the silicon oxidation temperature. Advantageously, it is also in a material having a thermal expansion coefficient similar to that of the second timepiece component 20.

Each second timepiece component 20 is inserted into a respective blind hole 41 of the support 40, the diameter of which corresponds to that of the second timepiece component 20 so that the latter is held in a stable and precise manner by the support 40 in the position illustrated in FIG. 2b.

FIG. 3 depicts a third step in the timepiece assembly method according to the embodiment of the invention, in which a first timepiece component 10 is assembled on each second timepiece component 20. To do that, the receiving opening 11 (the connecting hole) of the first timepiece component 10 is positioned facing the top end 21 of the second timepiece component 20 and then the first timepiece component 10 is slid downward along the second timepiece component 20 until it comes to rest on the upper surface 42 of the support 40.

FIG. 4a illustrates, in an enlarged view, the configuration obtained at the end of the third step which forms an intermediate configuration of assembly of the two timepiece components. The two timepiece components 10, 20 are positioned in their final relative position with respect to one another, but are not yet secured together. Specifically, their respective connecting surfaces 12, 22 are facing one another, but separated by a small distance d, as indicated in FIG. 4b, which represents a clearance between the two components. At this stage, the two timepiece components do not therefore come into contact with one another. This clearance allows relatively easy positioning of the two timepiece components, while at the same time guaranteeing minimal mobility between the two timepiece components in this unsecured temporarily assembled position. Advantageously, the distance d is less than or equal to 4 μm, or even less than or equal to 2 μm. Advantageously too, the distance d is greater than or equal to 1 μm, or even greater than or equal to 1.5 μm. The depth of the blind holes 41 of the support 40 is therefore chosen so that the second connecting surface 22 of the second timepiece component lies just above the upper surface 42 of the support, so as to be able to lie facing the first connecting surface 12 of the first timepiece component 10 after the latter has been positioned.

Note, as illustrated by FIGS. 2 and 3, the one same support 40 advantageously allows the simultaneous manufacture of a plurality of timepiece assemblies. This may be particularly advantageous if the first timepiece components 10 are produced by micromanufacturing from a wafer, notably a silicon wafer, and if these components are still secured to the wafer, for example by ties, thereby allowing the assemblies to be produced simultaneously for all or some of the components attached to the wafer. Naturally, the invention is not restricted to such an embodiment, but also covers embodiments in which a single timepiece assembly is produced.

Next, the timepiece assembly method implements a fourth step of securing the two timepiece components together. For that, the assembly obtained at the end of the third step is subjected to a heat treatment such that it generates the growth of a layer of silicon oxide at the surface of the first timepiece component 10 which is made of silicon. For that, the assembly is advantageously placed in an oxidation furnace and raised to a temperature of around 1100° C. or more generally to any temperature sufficient to cause the silicon to oxidize. Thus, advantageously, this temperature is between 800 and 1200° C., preferably in an oxidizing atmosphere (water vapor for example). In addition, the treatment time is chosen so as to achieve a sufficient thickness of oxidation to satisfactorily fix the two timepiece components together.

Specifically, as the silicon oxidizes, a layer of oxidized silicon forms on the surface of the first timepiece component, and this increases the overall volume thereof, including at its connecting surface which completely or partially surrounds the second timepiece component. Thus, by continuing the operation over a sufficient period of time, the distance d separating the two respective connecting surfaces of the two timepiece components is filled with the silicon oxide until a sufficient level of tightness between the two timepiece components at the direct contact between their respective connecting surfaces is achieved. This phenomenon is illustrated by FIG. 5, in which the first curve 51 illustrates the change in diameter of the receiving opening 11, which is in this case like a connecting hole of circular cross section, with respect to time during this oxidation operation. It can be seen that this diameter decreases significantly. According to the example depicted, this diameter has decreased by 2 μm in 10 hours of treatment, to become equal to the diameter of the second timepiece component 20 at the connecting surface 22 thereof, that diameter remaining constant and being depicted by the second curve 52.

The change in thickness of the layer of silicon oxide as a function of time obeys the following law:

$$Log ( {e}_{o x} ) = A {Log}^{2} ( t ) + B Log ( t ) + C$$

Where t is the heat treatment time, eₒₓ represents the thickness of the layer of oxidation, and A, B and C are constants.

It may thus be seen from FIG. 5 that a treatment of a duration of 40 hours allows the diameter of the receiving opening 11 to be reduced by 4 μm.

Notice that ceramic is able to withstand the silicon oxidation temperature and is unaffected, either in terms of its dimensions or in terms of its properties, by the heat treatment employed. In addition, the support 40 is made from a material likewise able to withstand this heat treatment so as to support the entity constantly throughout the heat treatment time.

The growth of the layer of oxidized silicon on the connecting surface 12 thus allows direct clamping-together of the respective two connecting surfaces 12, 22, which is continued until a secure enough connection compatible with the stresses to which the timepiece assembly is to be subjected in a timepiece movement is achieved, thus ensuring that the two timepiece components will hold together durably during operation of the timepiece assembly. Notice that in this embodiment, the two connecting surfaces therefore come into contact with one another at a securing surface, which in this embodiment is cylindrical in shape.

The geometry of the parts will advantageously be chosen to allow sufficient clearance before the heat treatment, thus in all instances allowing them to be assembled with minimal clearance, while at the same time achieving satisfactory securing-together by the heat treatment in an acceptable length of time. To do that, a connecting surface made of oxidized silicon in the timepiece assembly after heat treatment will advantageously be chosen to comprise a layer of oxidized silicon with a mean thickness greater than or equal to 1 μm or even greater than or equal to 1.5 μm and/or less than or equal to 4 μm. In a variant, the geometry of the parts will be chosen so that there is no contact between the first and second components prior to the oxidation heat treatment, but which achieves satisfactory securing-together by the oxidation heat treatment in an acceptable length of time. In that case, the use of a support 40 is advantageous, as illustrated in FIGS. 2 and 3.

Notice that it is notable that the wall delimiting the receiving opening 11 (the connecting hole) of the first timepiece component 10 is connected to the peripheral functional part of said first timepiece component 10 by a connection which in the embodiment described is rigid. More specifically, the hub of the wheel is connected by four rigid spokes to the functional peripheral part according to the example produced. In other words, the wall of the receiving opening 11 is immobile relative to this functional part. This connection between the receiving opening and the functional part will be qualified as a rigid connection and, more generally, such a timepiece component will be qualified as a rigid-type timepiece component. Naturally, this rigid connection can be formed by any other number of rigid spokes rather than the aforementioned four spokes, and by any other connecting structure that might not necessarily be in the form of spokes.

Such a rigid connection offers a significant advantage in the implementation of the timepiece assembly method of the invention, particularly during the final phase of the tightening-together of the two connecting surfaces through growth of a layer of oxidized silicon. Specifically, during this growth, a force is exerted on the connecting surfaces that are in contact: if the wall of the receiving opening (connecting hole) is mounted with the ability to move relative to the rest of the first timepiece component, notably relative to the functional part, the force exerted during the growth of the oxide might be liable to cause this wall of the receiving opening (of the connecting hole) to move, and might thus be absorbed by this movement, to the detriment of the desired tightening at the contacting surfaces. For this reason, a timepiece component of rigid type, within the meaning of the above definition, is particularly well suited to the timepiece assembly according to the invention.

FIG. 6 depicts by way of example part of a timepiece movement comprising a plurality of timepiece assemblies of rigid type, within the meaning described above. This part of timepiece movement more specifically forms a regulator device 1, notably comprising an escape wheel 2 pivoting about an axis A2, and a lock 3 comprising a first lock wheel 3a pivoting about a third axis A3a and a second lock wheel 3b pivoting about a fourth axis A3b, all three arranged in the one same plane P and made of silicon and assembled with their respective staffs made of ceramic using the timepiece assembly method according to the invention.

Other parts of the clockwork mechanism may benefit from the timepiece assembly according to the invention, such as, for example:
According to FIGS. 15 and 16, a balance wheel 60 with a balance-wheel pin 65, of the kind encountered in Swiss lever escapements. In this embodiment, the balance wheel 60, which is predominantly made of silicon, has a receiving opening 62 for receiving the balance-wheel pin 65. The contour of the receiving opening is closed and its geometry complements that of the balance-wheel pin 65. The balance-wheel pin 65, preferably made of monocrystalline or polycrystalline alumina, is introduced with a very small amount of clearance into the balance wheel 60, perpendicular to the first face thereof, until the engagement end of the balance-wheel pin 65 becomes flush with the second face of the balance wheel 60, which is parallel to the first face. Now that the two timepiece components have been positioned relative to one another, they are then assembled using the timepiece assembly method according to the invention.
In FIGS. 17 and 18, a balance wheel 70 with an impulse pin 75, such as those that may be encountered in types of escapement other than Swiss lever escapements. In this embodiment, the balance wheel 70, of which the two faces delimiting its height are parallel and predominantly made of silicon, has a receiving opening 72 for receiving the impulse pin 75. The profile of the receiving opening 72 is open, opening onto the periphery of the balance wheel 70. The impulse pin 75, preferably made of monocrystalline or polycrystalline alumina, is engaged with a very small amount of clearance in the balance wheel 70, parallel to the faces of the balance wheel 70. When the projecting length of the impulse pin 75 has been adjusted to suit, the two timepiece components are assembled using the assembly method according to the invention.
According to FIGS. 19 and 20, the shaping having an open-contour receiving opening 82, such as the opening 72 described hereinabove, also lends itself for example to the assembly of a jumper spur 85 with a jumper 80, such as those used in date mechanisms for example.

FIGS. 21 and 22 illustrate another solution for the assembly between a first component comprising a female part and a second component comprising a male part, providing seating for the male part that projects from the periphery of the female part. In this embodiment, assembly involves, in the first timepiece component 90, a receiving opening 92 the profile of which is open and does not pass through the full thickness of the first timepiece component 90. The depth of the receiving opening 92 is restricted to a portion, which may be as much as 40%, of the total thickness of the first timepiece component 90, so as to offer a seating 93 for the second timepiece component 95. In this configuration, the receiving opening is blind, closed off in the thickness of the first component, so that the second timepiece component 95 does not pass right through the first timepiece component 90.

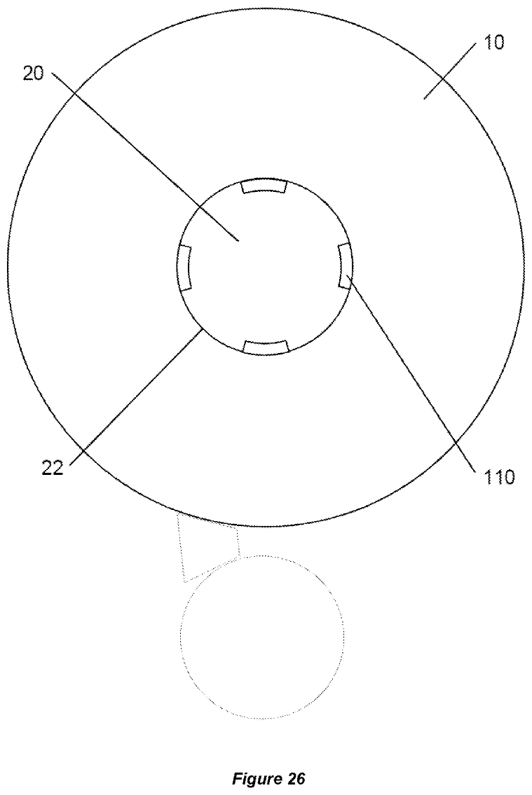

Very surprisingly, studies conducted by the applicant have demonstrated that the mechanical strength of the assembly increases if the connecting surface 12 intended to guide the second timepiece component is broken up by inserting at least one fluting 110, as illustrated in FIGS. 17, 18, 19, 20, 23, 24, 25 and 26. The at least one fluting 110 is provided for various purposes, such as for facilitating preassembly of the timepiece components, by reducing the contact area, and equally for facilitating the access of oxygen to the connecting surface 12 during the oxidation heat treatment, and even, notably in the case of a receiving opening with an open contour, for allowing the pre-positioning of the timepiece components to remain intact after oxidation by preventing any shifting of the male part that might be caused by the growth of the silicon oxide layer. The at least one fluting 110 may have all kinds of geometries, including those able to result in a succession of convex lobes on the inside of the connecting opening, as illustrated by FIG. 25. The at least one fluting 110 may also be formed on the connecting surface 22, as illustrated in FIG. 26.

As mentioned previously, the cross section of the receiving opening may be open or closed, blind or pass all the way through, and may assume a circular or U-shaped geometry, or else assume some other shape, for example ellipsoidal, ovoid, polygonal, etc.

As was described hereinabove, the invention is particularly well suited to the manufacture of a timepiece assembly comprising a staff made of ceramic. In addition to this, it is particularly well suited to the assembling of this ceramic staff with a first timepiece component made of silicon, notably a wheel made of silicon. Specifically, silicon is now being increasingly used for the manufacture of timepiece components because of its highly advantageous properties. However, it has the disadvantage of being fragile, notably brittle, making assembling it with another component very tricky. The invention is thus particularly advantageous for forming a timepiece assembly between a first timepiece component made of silicon and a second timepiece component made of ceramic.

Naturally, in an embodiment variant, the second timepiece component, notably a timepiece staff, could be made of some material other than ceramic, for example another very hard material that is able to withstand the aforementioned oxidation temperature. Thus, the embodiment described hereinabove, although specifically well suited to ceramic, could as a variant also be used for a timepiece component made of some material other than ceramic.

For example, the second component could be made of metal, notably of a metal alloy able to withstand the oxidation temperature. That metal could, nonlimitingly, be Ti, Zr, Nb, Mo, Ta, W and their respective alloys.

According to another example, the first and second components could be made of silicon Si. This configuration offers the advantages of reducing the oxidation time (the dimensions of the receiving opening of the first component decreasing and that of the body of the second component then increasing simultaneously) and/or of making it possible to operate with larger initial clearances.

Furthermore, as explained hereinabove, the invention is particularly well suited to the creation of a timepiece assembly of two timepiece components of rigid type. However, it may still be advantageous to use timepiece components of flexible type, the expression “of flexible type” being opposed to the expression “of rigid type”. A second embodiment of the invention therefore relies on a timepiece assembly comprising at least one timepiece component of flexible type, particularly having parts that are elastically mobile. In particular, the first timepiece component could have a receiving opening (connecting hole) wall connected by an elastically mobile connection to the functional part. Such a solution according to the second embodiment would not be as advantageous in the creation of the assembly of such, namely for the function of fixing the two timepiece components together, but would offer an additional advantage of facilitating the temporary assembly in the configuration of FIG. 3 in which the two timepiece components are temporarily assembled. Specifically, thanks to a slight elastic mobility of one or more walls of the receiving opening (of the connecting hole) relative to a functional part of the first timepiece component, it is possible to shift this wall during the temporary assembly of the two timepiece components, thereby making it possible to reduce the clearance between their respective connecting surfaces and thus reducing the heat treatment time needed to achieve the securing-together thereof.

Such an embodiment based on at least one timepiece component of flexible type therefore represents a compromise. This (very small degree of) flexibility will be chosen so as to allow the temporary arrangement of the two timepiece components while at the same time limiting the possible movement of the connecting surfaces in order to achieve sufficient securing-together through the growth of the layer of oxidized silicon.

To that end, FIG. 7 illustrates an embodiment variant of the regulator device of FIG. 6, comprising the same timepiece components, which thus keep the same references for ease of examination, but in which the geometry of the wheels is modified in order to introduce flexibility through an elastic connection connecting the walls of the connecting holes of the wheels, into which a ceramic staff is secured by a timepiece assembly according to the invention, to their respective peripheral functional parts. More specifically, as a preference, said wheels each comprise a central receiving opening (said connecting hole), delimited by elastic spokes. The dimensioning of the elastic spokes is defined in such a way as to provide an adequate retaining torque holding each of the wheels each on their respective staff.

Naturally, the invention is not restricted to the embodiments described hereinabove.

To that end, according to a first variant of the first or second embodiment, the second timepiece component 20 comprises a bearing face 23. In the case of a staff, this bearing face 23 may be formed by a larger-diameter portion of the staff. FIG. 8 to that end illustrates the third step in the method of manufacturing a timepiece assembly according to this embodiment variant. By comparing this embodiment with FIG. 3 that corresponds to the first embodiment described hereinabove, it becomes apparent that the main difference stems from the fact that a first timepiece component rests on the bearing face 23 of a second timepiece component rather than on the surface 42 of the support 40. The support 40 still holds at least one second timepiece component, but the depth of its blind holes 41 is reduced because the connecting surfaces of the two respective timepiece components are positioned spaced above the upper surface 42 of the support 40. Naturally, as a variant, any other geometry of the second timepiece component forming a surface to receive a first timepiece component and acting as a bearing face could be implemented. The presence of such a bearing face may facilitate the assembly operations but is not advantageous in the manufacture of the component because it entails additional machining operations and a greater bulk. Notice also that the first timepiece component maintains the same shape as in the embodiments described hereinabove. Its connecting surface remains as simple as possible, namely cylindrical. For example, as a preference, no spot face is added to its surface resting on the bearing face 23.

FIG. 9 depicts a second embodiment variant of the first or second embodiment, in which the temporary assembly of the third step of the timepiece assembly method is implemented without a support, for example directly on a silicon wafer 5 comprising at least one rough form of the first timepiece component 10, not fully detached from the wafer 5. In this second embodiment variant, the second timepiece component or components also has or have a bearing face 23 which rests on the upper surface 6 of the wafer 5, the latter thus also acting as a support in this configuration. Notice that during implementation of this second embodiment variant, the assembly formed in this configuration illustrated in FIG. 9 and resulting from the third step of the method is then oxidized in the fourth step of the method. The wafer 5 in its entirety is thus oxidized, its rough forms of the first timepiece components 10 which are intended to be detached thus being oxidized in this way prior to a subsequent step of detaching each first timepiece component 10, already assembled with its respective second timepiece component 20. Oxidation of the wafer in its entirety is not restricted to this embodiment, but can be performed in any configuration, notably the configuration illustrated in FIGS. 3 and/or 4. As in the preceding variant, the first timepiece component maintains the same shape as in the embodiments described hereinabove. Its connecting surface remains as simple as possible, namely cylindrical. For example, as a preference, no spot face is added to its surface resting on the bearing face 23. Notice that even through there is also a growth of oxidized silicon at the bearing face 23 forming a surface of contact between the two timepiece components, there is no securing-together function at this contact surface. Thus, the surface at which the two components are secured together is still the same cylindrical surface as that in the variants described hereinabove.

FIG. 10 illustrates a third embodiment variant which is likewise compatible with the first and the second embodiment of the invention and the various variants thereof. This third embodiment variant differs from all the variants described hereinabove in that it employs an intermediate third component made of silicon, distinct from the two timepiece components that are to be assembled, and the purpose of which is to participate in the timepiece assembly of said two timepiece components that are to be assembled. This intermediate third component comprises a third connecting zone comprising, on the one hand, an interior third connecting surface, intended to come into contact with the second connecting surface of the second timepiece component 20 and, on the other hand, an exterior third connecting surface intended to come into contact with the first connecting surface of the first timepiece component 10. During the oxidation fourth step of the assembly method, the third connecting zone of the intermediate third component will oxidize, leading to the growth of two layers of oxidized silicon, one interior and one exterior, which will respectively come into contact with the first connecting surface of the first timepiece component and with the second connecting surface of the second timepiece component until the three components are secured together as desired. In this third embodiment variant, the two connecting surfaces 12, 22 of the two timepiece components 10, 20 respectively are in indirect contact, connected by a continuity of material by the connecting zone of the intermediate third component, whereas in the embodiments described hereinabove, they were in direct contact. In the example illustrated, the intermediate third component 30 takes the form of a sleeve positioned around the second timepiece component at the connecting surface thereof, on the one hand, and inside the receiving opening (connecting hole) of the first timepiece component, facing the first connecting surface, on the other hand. This intermediate third component is assembled in the intermediate assembly configuration with clearance to each of the two timepiece components that are to be assembled. This clearance has the same dimensions as the clearance mentioned hereinabove between the two timepiece components. In this embodiment variant, the securing-together surface of the two timepiece components is doubled, being respectively at the exterior and interior surfaces. These two securing surfaces are of cylindrical shape in this case, but could have an open contour, or assume shapes, for example ellipsoidal, ovoid, polygonal, etc. and/or could be fluted. Notice that even though there is also a growth of oxidized silicon at the bearing face 23 forming a surface for contact between the two timepiece components, there is no securing-together function at this contact surface. Thus, the securing-together surfaces of the two components do still remain cylindrical, as in the variants described hereinabove.

This third embodiment variant is for example suitable when neither of the two timepiece components is made of silicon. These may therefore for example both be made completely or predominantly of ceramic. As a variant, one of them is predominantly made of ceramic, the other being made of another material. According to another example, it may be suitable if the respective connecting surfaces of the two timepiece components that are to be assembled do not have directly compatible dimensions, the receiving opening (the connecting hole) having for example too great a diameter in comparison with the second timepiece component to be able to achieve direct assembly between the two timepiece components.

FIGS. 11 to 14 respectively illustrate a fourth and a fifth embodiment variant in which the second timepiece component 20 has a variable transverse or radial cross section 25, which is to say a cross section 25 of which the surface area is variable, preferably continuously. In addition, it lies in the immediate vicinity of the connecting surface 22, as will be specified hereinbelow.

FIGS. 11 to 13 illustrate a fourth embodiment variant which can be likened to the first embodiment variant of FIG. 8, in which the bearing face 23 is replaced by a variable radial cross section 25, varying continuously between a boundary at the second connecting surface 22 and a larger cross section. As depicted in FIGS. 12 and 13, this variable radial cross section 25 takes the form of a portion of changing radial cross section, evolving continuously from a minimum radial cross-sectional area Se1, at the boundary with the second connecting surface 22, to a maximum radial cross-sectional area Se2. In this embodiment, the second timepiece component thus overall comprises a first cylindrical part, of cross-sectional area Se1, and a second cylindrical part, of greater cross-sectional area Se2, these two cylindrical parts being connected to one another by the variable radial cross section portion 25 which is interposed between them. As a preference, this aforementioned variation in cross section is linear. In a variant, it could take any other form. The second connecting surface 22 lies on the first cylindrical part, in the immediate vicinity of the variable radial cross section 25.

The first timepiece component 10 remains unchanged, and comprises a receiving opening 11 (a connecting hole). According to the embodiments, this receiving opening 11 has a constant cross section.

FIG. 12 particularly illustrates the advantage of such a construction when implementing the third step of the method. During the temporary assembly of the first timepiece component 10 with the second timepiece component 20, the receiving opening 11 (connecting hole 11) is slid with reduced clearance on the second timepiece component 20, with a clearance within the ranges of values specified hereinabove with reference to FIG. 4b, until its entry end comes to bear against the variable radial cross section portion 25 of the second timepiece component 20, to achieve the unsecured intermediate assembled configuration as depicted in FIG. 12. The contact thus made between the two timepiece components is therefore of the linear contact type. Notice that the variation in cross section of the variable radial cross section portion 25 is such that the maximum cross section Se2 is greater than the cross section of the receiving opening 11. By contrast, the minimum cross section Se1 is such that the receiving opening 11 can collaborate with minimal clearance with this minimum cross section of the second timepiece component 20, the clearance being that mentioned between the two connecting surfaces 12, 22 as described in the preceding variants.

In this intermediate assembly configuration, the entity is advantageously positioned in a support 40, as in the first variant depicted in FIG. 8. This support 40 notably holds the second timepiece component or components 20 in a vertical orientation so as to maintain the line of contact between the two timepiece components in a substantially horizontal plane perpendicular to the axis of the second timepiece component 20, under the effect of gravity. According to the fourth embodiment variant, the linear contact between the two components is of circular shape, but could assume any sort of geometry, or an open contour, and/or have fluting forming a discontinuous linear contact.

FIG. 13 depicts the assembly obtained after implementation of the fourth step, which involves securing the two timepiece components together by a silicon oxidation heat treatment as described hereinabove. At the end of this fourth step, a layer of silicon oxide 15 of uniform thickness eₒₓ is formed at the surface of the component made of silicon, in this instance the first timepiece component 10. As explained previously, the formation of this layer of silicon oxide is accompanied by an increase in volume which moves the first connecting surface 12 of the first timepiece component 10 until it comes into contact with the second connecting surface 22 of the second timepiece component 20 so as to cause the two timepiece components to become secured to one another. Notice that the uniformity of the thickness of the layer of silicon oxide 15 is also the reason for a rounding of the corners of the first timepiece component 10 made of silicon, as indicated by the circular arcs in FIG. 13.

According to this embodiment variant, as the layer of silicon oxide gradually builds up on the surface of the first timepiece component 10, the cross section of the receiving opening 11 (the connecting hole) decreases, causing the first timepiece component 10 to move relative to the second timepiece component 20. Specifically, the zone of linear contact gradually works its way up (in FIG. 12, more generally moves along the axis of the second timepiece component) as its cross section decreases. The variable radial cross section portion 25 of the second timepiece component 20 therefore forms a guide ramp guiding the relative movement of the first timepiece component during the fourth step, the oxidation step, of the method. This phenomenon continues until the first timepiece component 10, more specifically its line of contact with the second timepiece component 20, reaches the boundary between the variable radial cross section portion 25 and the second connecting surface 22. At this point, the growth of the layer of silicon oxide no longer causes the first timepiece component 10 to move but finalizes the securing-together of their two respective connecting surfaces 12, 22, according to the final configuration of FIG. 13.

Notice that the relative movement of the two timepiece components 10, 20 according to this fourth embodiment variant encourages movement in two directions, an axial direction as described above, but also a radial direction, which allows relative recentering of the two timepiece components 10, 20 should there have been any offset in the intermediate configuration.

Finally, this shaping of the second timepiece component 20 advantageously makes it possible, on the one hand, to form a means of prepositioning the first timepiece component 10 and, on the other hand, to avoid a sudden variation in cross section on the second timepiece component 10, which would be detrimental in terms of mechanical strength, particularly if the material used has little impact resistance and/or if the cross sections involved are small. It is also apparent that this embodiment very much promotes the obtaining of a uniform layer of silicon oxide 15, and a precise relative positioning of the two timepiece components after heat treatment. These aforementioned advantages are particularly noticed relative to a configuration using a bearing face on the second timepiece component, for example according to FIGS. 8 and 9, and more particularly still a configuration combining such a bearing face with a spot face arranged at the receiving opening 11 of the first timepiece component 10. This embodiment variant thus optimizes the reinforcing of the robustness of the oxidation shrink-fitting method. An advantage of this embodiment variant involving linear contact prior to heat treatment stems notably from the uniformity of the layer of silicon oxide obtained, as mentioned hereinabove, which can be explained by the fact that, with the exception of the line of contact, the entirety of the surfaces of the timepiece component made of silicon remains exposed in the same way to the oxidizing atmosphere prevailing during the heat treatment.

According to one embodiment, the variable radial cross section portion 25 of the second timepiece component 20 may be produced by a turning operation, notably if this second timepiece component is fully or partially made of ceramic, as mentioned hereinabove. In addition, this variable radial cross section 25 may exhibit a linear variation, in which case it exhibits a frustoconical shape. According to one embodiment, it may have an opening angle “a” of the frustoconical portion that represents a compromise between a small value, which promotes the mechanical strength of the timepiece component through the absence of an abrupt variation in its radial cross section, and therefore the absence of a concentration of stresses in this zone, and a larger value, which promotes the relative positioning of the two timepiece components, because of lower sensitivity to manufacturing tolerances since dimensional spread on the receiving opening 11 of the first timepiece component 10 or on the variable radial cross section portion 25 of the second timepiece component 20 are compensated for by small axial movements. Advantageously, the angle “a” may be between 10 and 80 degrees, or even between 30 and 60 degrees. The choice of an angle “a” equal or close to 45 degrees for example represents a good compromise.

FIG. 14 depicts a fifth embodiment variant which can be likened to the second variant of FIG. 9, in which the bearing face has been replaced by a variable radial cross section portion 25 similar to that of the fourth variant described above. The operation obtained during the oxidation step is similar to that described for the preceding variant, and the advantages obtained are likewise very similar.

The invention is not restricted to the embodiments described. For example, certain embodiment variants described hereinabove could be combined with one another to form other embodiment variants.

The invention also relates to a timepiece assembly as results from the timepiece assembly method described hereinabove. This timepiece assembly therefore comprises a first timepiece component assembled with a distinct second timepiece component, the first timepiece component comprising at least a functional part and a receiving opening (connecting hole) distinct from said functional part, the wall delimiting said receiving opening forming a first connecting surface, the second timepiece component comprising a second connecting surface and being assembled securely to the first timepiece component by direct or indirect contact between respective first and second connecting surfaces of said first and second timepiece components.

Indirect contact between said two connecting surfaces is the term that will be used here for a configuration in which one or more other layers of materials, distinct from said two timepiece components, are interposed between said two connecting surfaces, forming continuity of material between said two connecting surfaces, to allow the two timepiece components to be secured to one another.

In any case, at least one of the first and second connecting surfaces or an interior and/or exterior third connecting surface of an optional intermediate third component is made of silicon oxidized by heat treatment so that the first and second timepiece components are secured to one another by the growth of a layer of oxidized silicon.

It is therefore evident that the surface of oxidized silicon is sufficient, through its growth, for coming into engagement with a corresponding connecting surface to form a sufficiently tight fit at the connecting surfaces to secure the two timepiece components together. As explained hereinabove, the two timepiece components are first of all positioned in an intermediate assembly configuration prior to the growth of a layer of silicon which is oxidized by heat treatment and secures the two timepiece components in their final position corresponding to their intermediate assembly configuration. Such a timepiece assembly is therefore different from a timepiece assembly that may comprise a component made from oxidized silicon but connected to another component by a traditional means such as bonding or driving rather than through the intermediary of the oxidized silicon. In the latter instance, the oxidized silicon would be unavoidably damaged in a way that could be detected, through the presence of defects, by a mechanical connection performed subsequent to oxidation, at the connection between two components, leading to the risk of chipping or cracking of the layer of oxidized silicon, in addition to the deformation thereof. By contrast, with the implementation of the invention, the layer of oxidized silicon remains free of defects at the timepiece component connecting surface, more specifically at the surfaces via which they are secured together. Furthermore, with the implementation of the invention, the addition of any other means of fixing the two timepiece components together is not required, unlike in a traditional solution, although the invention is not incompatible with the optional use of a distinct additional second fixing means.

The timepiece components described hereinabove are of the wheel type, such as an escape wheel, or of the pinion type, such as an escape pinion, or may be a hairspring, on the one hand, and a timepiece staff on the other. Naturally, the invention applies more generally to any first timepiece component of “female” type assembled with any second timepiece component of “male” type.

Furthermore, as described hereinabove, the invention is particularly well suited to at least one of the timepiece components being made of ceramic, or predominantly of ceramic. This timepiece component may be the first and/or the second timepiece component. This timepiece component may be the timepiece component of “female” type and/or the second timepiece component of “male” type.

Notice that said at least one connecting surface made of silicon oxidized by heat treatment or more generally the connecting surface of the timepiece component of female type may surround the second, male-type, timepiece component completely, or over at least 70% of its periphery, or over at least 40% of its periphery, considering at least one of its cross sections in a transverse plane, which is to say a plane substantially perpendicular to its axis or its direction of longitudinal extent.

Furthermore, the mechanical connection between the two components is achieved over the entire height of the connecting surface delimiting the receiving opening of the first timepiece component. The growth of oxidized silicon is therefore achieved between the two connecting surfaces, which is to say in the transverse direction, as defined hereinabove, which is also a radial direction in instances in which the second component takes the form of a staff. The resulting securing surface securing the two timepiece components together extends perpendicular to this transverse or radial growth of oxidized silicon, on the surface of the receiving opening of the female-type component.

Still considering a transverse (radial) cross section at the connection between the two timepiece components, the receiving opening (connecting hole) of the first timepiece component may have a circular first cross section and the connecting surface of the second timepiece component may have a circular second cross section, the diameter of the circular first cross section being strictly greater than or equal to the diameter of the circular second cross section prior to said oxidation by heat treatment. As a variant, one of the first or second connecting surfaces may have a circular first cross section, the other having a non-circular, notably ovoid or elliptical or polygonal, cross section to allow the assembly of said two timepiece components to self-center when they are positioned in the intermediate assembly configuration. As a further variant, said two first and second cross sections of the first and second connecting surfaces respectively may have a cross section of the same non-circular shape, notably ovoid or elliptical or polygonal shape. As a further variant, the first and/or second connecting surfaces may have a cross section of noncontinuous shape and/or that may or may not be constant over the whole of the receiving opening. From that it is clear that the securing surface or surfaces of the two timepiece components are preferably of cylindrical or even ovoid or elliptical or polygonal shape or inscribed inside a cylindrical shape when one securing surface is not continuous, or even ovoid or elliptical or polygonal.

The receiving opening 11 (connecting hole) of the first timepiece component 10 may be a through-opening or a blind opening.

The connecting surface 12 of the first timepiece component 10, which complements the connecting surface 22 of the second timepiece component 20, may advantageously be broken up by the insertion of flutings 110 intended notably to facilitate the access of oxygen to the connecting surface 12 during the oxidation heat treatment.

As a variant, the creation of the alternating sequence of guide portions and of flutings may be applied to the connecting surface 22 of the second timepiece component 20, as illustrated in FIG. 26.

The connecting surface of one timepiece component that is either the first timepiece component or the second timepiece component, which is not made of oxidized silicon but for example ceramic, may be structured to increase its roughness, or may comprise knurling or fluting or a keyway and/or a flat.

The connecting surface of a timepiece component made predominantly of ceramic may be treated to render it chemically compatible with silicon oxide.

The second timepiece component may comprise a supporting bearing face.

As a variant, the second component may have a portion of variable cross section, notably which increases continuously from a boundary with its second connecting surface, this continuously increasing cross section portion thus being positioned outside the receiving opening of the first timepiece component, in the immediate vicinity of an end of said receiving opening. This portion of variable cross section was described in greater detail in the embodiment variants referencing FIGS. 11 to 14.

Said connecting surface made of oxidized silicon may have a mean thickness greater than or equal to 1 μm, or even greater than or equal to 1.5 μm. It may have a mean thickness less than or equal to 4 μm.

The invention also relates to a timepiece movement comprising one or more timepiece assemblies as described hereinabove.

The invention also relates to a timepiece, which comprises at least one timepiece assembly as described hereinabove or such a timepiece movement.

1. A timepiece assembly comprising:
a first timepiece component,
a second timepiece component distinct from the first timepiece component, the first timepiece component being assembled with the distinct second timepiece component,
the first timepiece component comprising a receiving opening or connecting hole, the wall delimiting the receiving opening or the connecting hole forming a first connecting surface,
the second timepiece component comprising a second connecting surface and being assembled securely with the first timepiece component by direct or indirect contact between the respective first and second connecting surfaces of the first and second timepiece components at a securing surface,
wherein at least one of the first and second connecting surfaces or a third connecting surface of an optional intermediate third component is made of silicon oxidized by heat treatment so that the first and second timepiece components are secured to one another by the growth of a layer of oxidized silicon.

2. The timepiece assembly as claimed in claim 1, wherein the receiving opening f the first timepiece component has a constant cross section over an entirety of the first connecting surface.

3. The timepiece assembly as claimed in claim 1, wherein the second timepiece component has a portion of variable radial cross section which increases continuously from a boundary with the second connecting surface, the portion of variable radial cross section being positioned outside the receiving opening in an immediate vicinity of an end of the receiving opening.

4. The timepiece assembly as claimed in claim 1, wherein at least one of the first and second timepiece components is predominantly made of ceramic.

5. The timepiece assembly as claimed in claim 1, wherein the securing surface or surfaces of the first and second timepiece components is or are of cylindrical, ovoid, elliptical or polygonal shape or inscribed inside a cylindrical, ovoid, elliptical or polygonal shape.

6. The timepiece assembly as claimed in claim 1, wherein
at least one of the first and second timepiece components is predominantly made of silicon, and
the first connecting surface of the first timepiece component and the second connecting surface of the second timepiece component are in direct contact,
the connecting surface of the component predominantly made of silicon being made of silicon oxidized by heat treatment.

7. The timepiece assembly as claimed in claim 1, wherein the assembly comprises an intermediate third component predominantly made of silicon, which has a shape of a sleeve, comprising a connecting zone forming an exterior third connecting surface and an interior third connecting surface made of silicon oxidized by heat treatment, the interior third connecting surface being in direct contact with the second connecting surface of the second timepiece component and the exterior third connecting surface being in direct contact with the first connecting surface of the first timepiece component.

8. The timepiece assembly as claimed in claim 1, wherein
the first timepiece component comprises at least one functional part distinct from the receiving opening, and
the wall delimiting the receiving opening of the first timepiece component is connected to the functional part of the first timepiece component (i) by a rigid connection so as to remain substantially immobile relative to the functional part, or (ii) by a flexible connection.

9. The timepiece assembly as claimed in claim 1, wherein the securing surface of the first and second timepiece components surrounds the second timepiece component over at least 40% of a periphery thereof.

10. The timepiece assembly as claimed in claim 1, wherein the first and second timepiece components have geometries so that the first and second timepiece components are assembled with minimum clearance prior to oxidation by heat treatment of at least one of the connecting surfaces made of silicon.

11. The timepiece assembly as claimed in claim 1, wherein said
the receiving opening of the first timepiece component has a circular first cross section, and wherein said
the connecting surface of the second timepiece component has a circular second cross section, the diameter of the circular first cross section being strictly greater than the diameter of the circular second cross section before oxidation by heat treatment, or one of the first and second connecting surfaces has a circular cross section, the other having a non-circular cross section, to allow the assembly of the first and second components to self-center, or the first and second cross sections of the first and second connecting surfaces respectively have a cross section of the same non-circular shape.

12. The timepiece assembly as claimed in claim 1, wherein the receiving opening (H) of the first timepiece component is a through-opening or a blind opening.

13. The timepiece assembly as claimed in claim 1, wherein
the assembly comprises at least one connecting surface of a timepiece component that is either the first timepiece component or the second timepiece component that has been structured to increase a roughness thereof, or comprises knurling, fluting. a keyway and/or a flat, and/or
the second timepiece component comprises a supporting bearing face.

14. The timepiece assembly as claimed in claim 1, wherein the connecting surface made of oxidized silicon comprises a layer of oxide with a mean thickness greater than or equal to 1 μm.

15. The timepiece assembly as claimed in claim 1, wherein the second timepiece component is a staff which allows the timepiece assembly to be mounted with ability to rotate inside a timepiece movement.

16. The timepiece assembly as claimed in claim 1, wherein the first timepiece component is a wheel, , or a pinion, or a hairspring.

17. A timepiece comprising at least one timepiece assembly as claimed in claim 1.

18. A timepiece comprising a timepiece movement as claimed in claim 17.

19. A method for manufacturing a timepiece assembly comprising a first timepiece component and a distinct second timepiece component, wherein the method comprises:
assembling the first and second timepiece components in a minimal-clearance intermediate configuration so that the second timepiece component is positioned in a receiving opening or connecting hole of the first timepiece component, a first connecting surface of the first timepiece component being positioned facing a second connecting surface of the second timepiece component, optionally via an interior and exterior third connecting surface of an intermediate third component of the which has a shape of a sleeve, at least one of the first and second connecting surfaces or the optional interior and exterior third connecting surface being made of silicon;
heat treating the timepiece assembly in the intermediate configuration so as to obtain growth of a layer of oxidized silicon on the at least one connecting surface made of silicon until a predefined level of securing-together of the first and second timepiece components (is obtained.

20. The method as claimed in the claim 19, wherein, in the intermediate configuration, a radial clearance between the first and second timepiece components is less than or equal to 2 μm, and/or
wherein:
the second timepiece component is inserted into and held in the opening of a support able to withstand the temperature of the heat treatment so as to hold the second timepiece component; or
a plurality of second timepiece components are assembled with a plurality of rough forms of respective first timepiece components which are temporarily held together on a wafer used for the manufacture thereof.

21. The method as claimed in claim 19, wherein, in the intermediate configuration, one end of the receiving opening of the first timepiece component bears linearly, continuously or discontinuously, against a portion of variable radial cross section of the second timepiece component.

22. The method as claimed in claim 19, wherein the heat treatment is performed at a temperature in a range of from 800 to 1200° C.
